(19) United States
(12) Patent Application Publication
(10) Pub. No.: US 2026/0158761 A1
(43) Pub. Date: Jun. 11, 2026

(54) SYSTEM AND METHOD FOR CORRUGATED CARDBOARD

(71) Applicant: BHS Corrugated Maschinen- und Anlagenbau GmbH, Weiherhammer (DE)

(72) Inventors: Thomas Hecky, Weiden (DE); Maximilian Rauscher, Vilseck (DE)

(21) Appl. No.: 18/866,413

(22) PCT Filed: May 23, 2023
(86) PCT No.: PCT/EP2023/063769

§ 371 Date: Nov. 15, 2024

(30) Foreign Application Priority Data
May 24, 2022 (DE) 102022205208.0

(51) Int. Cl. B31F 1/28

(52) U.S. Cl. CPC B31F 1/2836; B31F 1/2813; B31F 1/284

(57) ABSTRACT

A system comprises a corrugator (1) having a first corrugated-cardboard production device (2) for producing a first corrugated cardboard web (21) which is laminated on one side, a laminating-web unrolling device (67) for unrolling a laminating web (72), and a joining device (88) for joining the first corrugated cardboard web (21) which is laminated on one side and the laminating web (72) together to form a corrugated cardboard web (91) which is laminated on both sides and which has a first outer web (21, 72) and a second outer web (72, 21). The corrugator (1) also has at least one cutting device (97) for producing corrugated cardboard sheets (102) from the corrugated cardboard web (91) which is laminated on both sides, the cutting device being downstream of the joining device (88). The system additionally comprises a processing assembly (108), which is designed to automatically adapt a tension of the second outer web (72, 21) to a tension of the first outer web (21, 72) if necessary, so that, at least in the transport direction of the corrugated cardboard sheets (102), the corrugated cardboard sheets (102) are flat or adhere to flatness target values.

The present patent application claims the priority of German patent application DE 10 2022 205 208.0, the contents of which are incorporated herein by reference.

The invention relates to a system with a corrugator for producing corrugated cardboard. Furthermore, the invention is directed at a method for producing corrugated cardboard.

The production of corrugated cardboard is generally known from public prior use. It is often the case that, during the production of corrugated cardboard, the corrugated cardboard sheets produced have a curvature, which is disadvantageous and undesirable.

The object addressed by the invention is that of providing a system comprising a corrugator which is capable of producing particularly high-quality, in particular (substantially) flat, corrugated cardboard sheets in an extremely functionally reliable and efficient manner. The system is also intended to be comparatively simple. A corresponding method is also to be provided.

This object is achieved according to the invention by the features specified in independent claims 1 and 15. The essence of the invention lies in adapting the (mechanical) tension/web tension of the second outer web to match the mechanical tension/web tension of the first outer web, if necessary, by the processing assembly. At least the tension of the second outer web can be adapted. Absolute control of a web tension level is preferably unnecessary.

The aim in particular consists in adapting the tension of the first outer web and the second outer web to match one another in such a way that the flatness of the corrugated cardboard sheet is constant, at least in the running direction, without the corrugated cardboard sheet bending upward or downward.

A tension level will depend, for example, on a material dependency/condition and/or, if necessary, additional required interventions which preferably (must) be carried out by an operator. It is advantageous to have a tension level which is as low as possible and which expediently lies within certain or predetermined limits for a minimum and/or maximum tension. The tension level is preferably adapted to match a basic paper material of the webs (grade, basis weight or the like).

It is useful to be able to select, preferably by an operator, which web is the first outer web. An outer web is or includes a web which is on the outside of the corrugated cardboard (web) which is laminated on both sides or the finished corrugated cardboard sheets and is thus visible from the outside. For example, the first outer web forms an outer cover or inner cover, while the second outer web forms the corresponding other cover. The web which does not form the first outer web thus forms the second outer web. During corrugated cardboard production or in the finished, deposited corrugated cardboard sheet, the outer cover is preferably positioned facing upward or above the corresponding inner cover.

It is expedient for the finished corrugated cardboard sheets to be flat or to adhere to flatness target values both in the transport direction and perpendicularly thereto in the transverse direction.

The processing assembly is in particular an information or data processing assembly, preferably an electrical or electronic one. It is preferably designed as a control assembly and is, for example, part of the corrugator. Alternatively, the processing assembly is, for example, superordinate to the corrugator and is at least temporarily connected thereto for transmitting signals.

The first corrugated-cardboard production device preferably comprises a first corrugating assembly for producing a first corrugated web from a first material web and a first glue application apparatus for applying glue to the first corrugated web. It is expedient if the first corrugated-cardboard production device also has a first pressure apparatus for pressing a further material web and the first corrugated web provided with glue against one another to form the first corrugated cardboard web which is laminated on one side.

It is expedient if a first and a second unrolling device for unrolling the first and further material webs are arranged upstream of the first corrugated-cardboard production device. The unrolling devices are preferably designed as splicing devices for unrolling continuous material webs.

It is expedient if the laminating-web unrolling device is designed as a laminating-web splicing device for unrolling a continuous laminating web.

The joining device is preferably designed as a heating and pulling device. It is preferably capable of pressing the first corrugated cardboard web which is laminated on one side and the laminating web toward each other and, directly or indirectly, bonding them together by gluing.

The at least one cutting device is preferably designed as a cross-cutting device. It is expedient for it to comprise at least one cutting means, such as a cutting knife, cutting blade or the like.

Further advantageous embodiments of the invention are specified in the dependent claims.

The specification assembly according to dependent claim 2 leads to a particularly user-friendly system. It is advantageous if the system or the corrugator is operated by the specification assembly. It is expedient if the specification assembly has an input device for entering a target tension for the first outer web. The input device comprises, for example, a slider, a rotary wheel or the like, in order in particular to allow a curvature correction of the corrugated cardboard sheets or to adapt a tension difference between the outer webs. A tension is entered only or exclusively for the first outer web.

It is advantageous if the specification assembly is superordinate to the corrugator. Alternatively, this is part of the corrugator.

It is expedient if a specification is made by the specification assembly when starting a quality. If a tension difference between the first outer web and the second outer web was not zero for the last storage process, in particular quality storage, the corresponding tension difference should expediently be taken into account. Preferably, at least one tension minimum value and/or maximum value is stored as a standard value which is to be defined and can preferably be manipulated for all qualities if required.

Predefined data can be expediently adjusted by manual intervention in the laminating region. If an adaptation is generally to be made, the operator can request the data in the specification order. If this is a unique result, it is expedient to ignore the change.

The system according to dependent claim 3 is particularly simple. Only the target tension for the first outer web needs to be entered. The processing assembly automatically or independently adapts the tension of the second outer web. This is something it is able to do.

According to dependent claim 4, a master-slave relationship is provided for adapting the tension of the second outer web to match the tension of the first outer web.

The tension comparison unit according to dependent claim 5 preferably determines a difference between the tension of the first outer web and the tension of the second outer web. This allows for particularly effective tension adaptation or adjustment.

The system according to dependent claim 6 is extremely functionally reliable.

The system according to dependent claim 7 results in comparatively easy-to-plan corrugated cardboard sheets. In particular, the aim is always to achieve web tensions which are aligned with one another, which initially already ensure good flatness of the corrugated cardboard sheets.

According to dependent claim 8, the system comprises a tension difference control assembly, which is particularly efficient and leads to high-quality corrugated cardboard.

According to dependent claim 9, the first outer web is formed by the laminating web or is part of the first corrugated cardboard web which is laminated on one side. The second outer web is formed by the other web or is part thereof.

The at least one laminated web tension changing device according to dependent claim 10 is designed, for example, as a braking and/or driving device. For example, it is part of the laminating-web unrolling device and is able to accordingly influence the unrolling of the laminating web. By increasing the unrolling braking force when unrolling the laminating web, the tension of the laminating web is increased. By reducing the unrolling braking force when unrolling the laminating web, the tension of the laminating web is reduced.

Alternatively, the at least one laminating web tension changing device is, for example, designed separately, in particular to the laminating web unrolling device, and is able to accordingly act on the laminating web. It is then designed, for example, as a laminating web tension changing roller. In order to brake the laminating web, i.e. to increase the tension of the laminating web, the peripheral speed of the corresponding laminating web tension changing roller is reduced such that it is lower than the prevailing transport speed of the laminating web. Alternatively or additionally, the wrap angle of the laminating web around the corresponding laminating web tension changing roller can be increased. In order to drive the laminating web, i.e. to reduce the tension of the laminating web, the peripheral speed of the corresponding laminating web tension changing roller is increased such that it is greater than the prevailing transport speed of the laminating web. Alternatively or additionally, the wrap angle of the laminating web around the laminating web tension changing roller can be reduced.

The at least one first corrugated cardboard web tension changing device according to dependent claim 11 is preferably designed as a braking and/or driving device and is able to accordingly act on the first corrugated cardboard web which is laminated on one side. Expediently, it is formed by at least one first corrugated cardboard web tension changing roller. It is advantageous if the at least one first corrugated cardboard web tension changing device is arranged on a bridge of the corrugator. In order to brake the first corrugated cardboard web which is laminated on one side, i.e. to increase the tension of the first corrugated cardboard which is laminated on one side, the peripheral speed of the corresponding first corrugated cardboard web tension changing roller is reduced such that it is lower than the prevailing transport speed of the first corrugated cardboard web which is laminated on one side. Alternatively or additionally, the wrap angle of the first corrugated cardboard web which is laminated on one side around the corresponding first corrugated cardboard web tension changing roller can be increased. In order to drive the first corrugated cardboard web which is laminated on one side, i.e. to reduce the tension of the first corrugated cardboard web which is laminated on one side, the peripheral speed of the corresponding first corrugated cardboard web tension changing roller is increased such that it is greater than the prevailing transport speed of the first corrugated cardboard web which is laminated on one side. Alternatively or additionally, the wrap angle of the first corrugated cardboard web which is laminated on one side around the corresponding first corrugated cardboard web tension changing roller can be reduced.

The at least one laminated web tension measuring device according to dependent claim 12 is designed, for example, as a laminated web tension measuring roller or sensor roller. It is advantageous if the at least one laminating web tension measuring device rests directly against the laminating web. It is preferably capable of measuring the tension of the laminating web or providing a measured value correlating with the tension of the laminating web. The measurement is carried out, for example, continuously or at cyclical intervals. It is expedient if the at least one laminated web tension measuring device has at least one integrated or attached force transducer, force measuring block, force measuring bearing and/or tensile force sensor. It emits a corresponding measured signal. Different laminated web tension measuring devices can be used as an alternative.

The at least one first corrugated cardboard web tension measuring device according to dependent claim 13 is expediently designed as a first corrugated cardboard web tension measuring roller or sensor roller. It is advantageous if the at least one first corrugated cardboard web tension measuring device rests directly against the first corrugated cardboard web which is laminated on one side. It is preferably capable of measuring the tension of the first corrugated cardboard web which is laminated on one side or providing a measured value correlating with the tension of the first corrugated cardboard web which is laminated on one side. The measurement is carried out, for example, continuously or at cyclical intervals. It is advantageous if the at least one first corrugated cardboard web tension measuring device has, for example, at least one integrated or attached force transducer, force measuring block, force measuring bearing and/or tensile force sensor. It emits a corresponding measured signal. Different first corrugated cardboard web tension measuring devices can be used as an alternative.

The at least one curvature determination device according to dependent claim 14 preferably operates without contact. It is expedient for this to be designed as a sensor, camera or the like and is able to deliver a corresponding measured signal. Such a system is particularly user-friendly and requires extremely little outlay in terms of personnel. Alternatively or additionally, the curvature of the corrugated cardboard sheets is determined manually.

The developments according to dependent claims 2 to 14 also relate to preferred developments of the method according to independent claim 15.

For example, the corrugator has a plurality of corrugated-cardboard production devices for producing a plurality of corresponding corrugated cardboard webs which are laminated on one side. It is expedient if the corrugated cardboard web which is laminated on both sides consists of three, five or seven layers.

It is expedient if the corrugator comprises at least one second or further corrugated-cardboard production device for producing at least one second/further corrugated cardboard web which is laminated on one side and preferably at least one second/further corrugated cardboard web tension changing device which is assigned to the at least one second corrugated cardboard web which is laminated on one side and is at least temporarily connected to the processing assembly for transmitting signals in order to change a tension of the at least one second corrugated cardboard web which is laminated on one side when necessary. Such a system allows for the efficient production of high-quality corrugated cardboard sheets which have more than three layers and are flat. It is expedient if the at least one second corrugated-cardboard production device is designed in a similar manner to the first corrugated-cardboard production device. Expediently, the at least one second corrugated cardboard web tension changing device is designed in a similar manner to the at least one first corrugated cardboard web tension changing device. Alternatively, they differ from one another. It is advantageous if at least one second/further corrugated cardboard web tension measuring device is also provided for measuring the tension of the at least one second corrugated cardboard web which is laminated on one side, which second/further corrugated cardboard web tension measuring device is preferably designed in a similar manner to the first corrugated cardboard web tension measuring device. Alternatively, they differ from one another. Preferably, the at least one second corrugated cardboard which is web laminated on one side, if present, is located inside the corrugated cardboard (web) which is laminated on both sides or the finished corrugated cardboard sheet.

A preferred embodiment of the invention will be described below by way of example with reference to the accompanying drawings. In the figures:

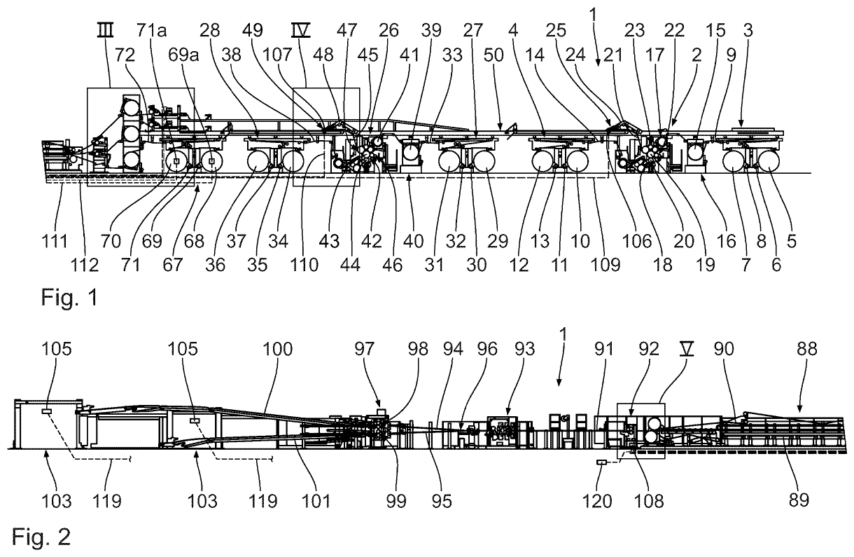

FIG. 1 shows a first part of a corrugator which is part of a system according to the invention,

FIG. 2 shows a second part of the corrugator which is connected to the first part,

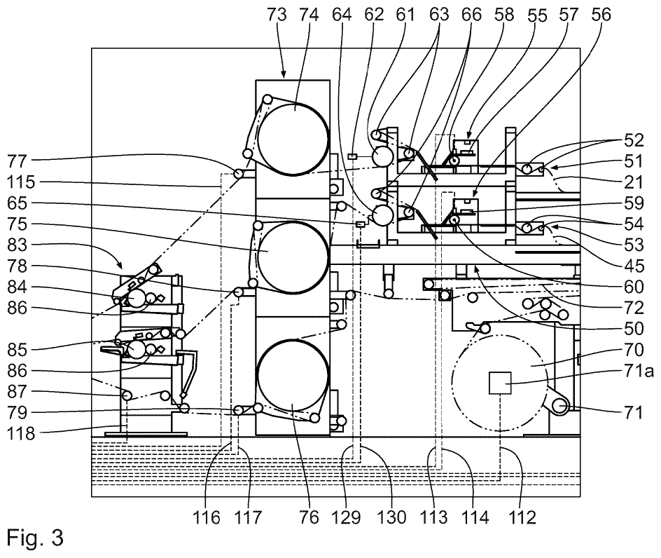

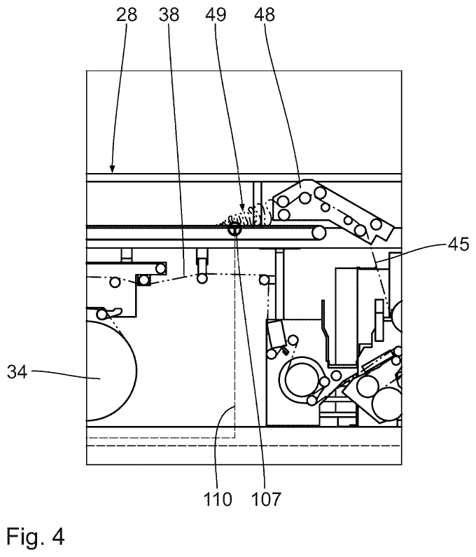

FIG. 3 is an enlarged view of detail III marked in FIG. 1, which shows a preheating device arranged upstream of the joining device together with its surroundings,

FIG. 4 is an enlarged view of detail IV marked in FIG. 1, which illustrates an example of an outlet of an overhead transport apparatus together with its surroundings,

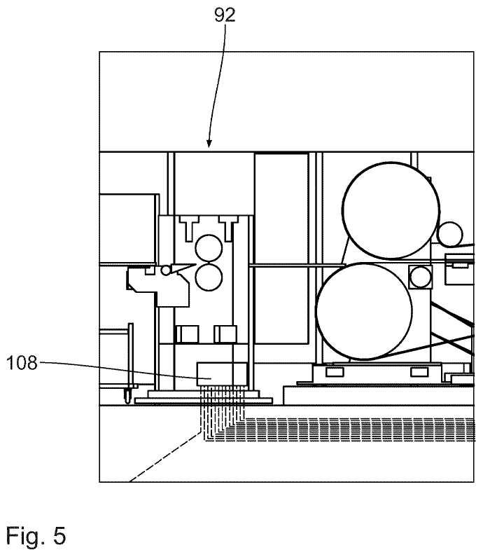

FIG. 5 is an enlarged view of detail V marked in FIG. 2, which shows, among other things, a processing assembly,

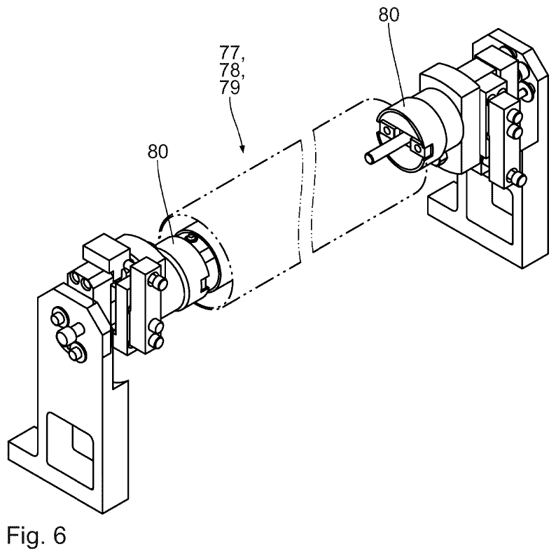

FIG. 6 is a perspective view of a tension measuring device which is part of the illustrated corrugator,

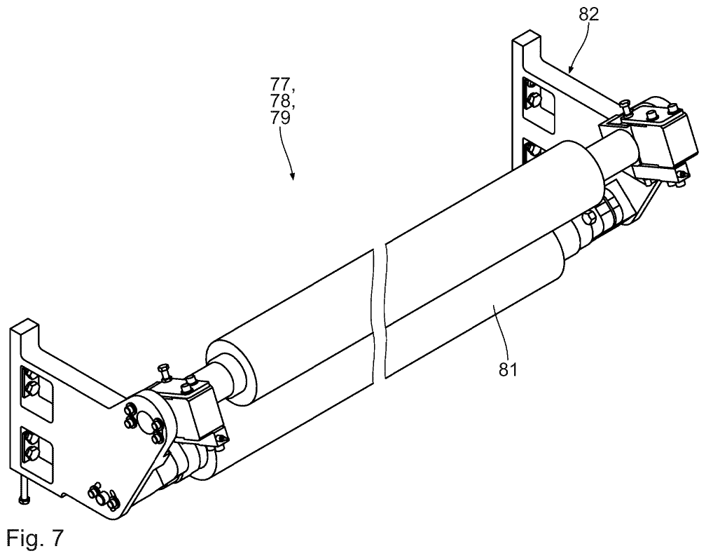

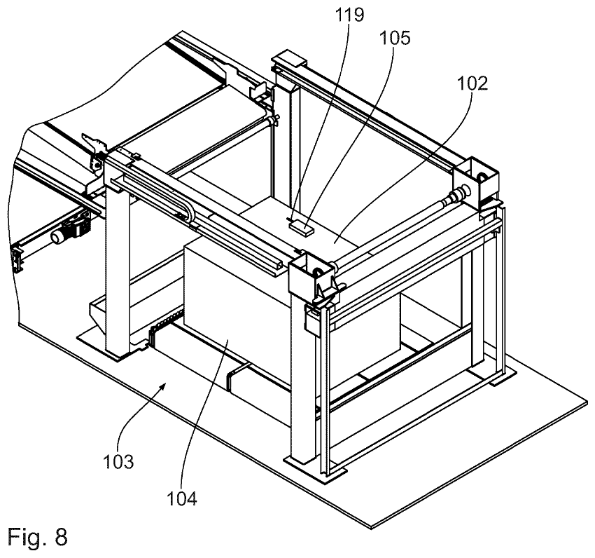

FIG. 7 is a perspective view of an alternative tension measuring device which is part of the corrugator shown and is mounted in a holder,

FIG. 8 is a perspective view illustrating a stacking device for the illustrated corrugator together with a curvature determination device,

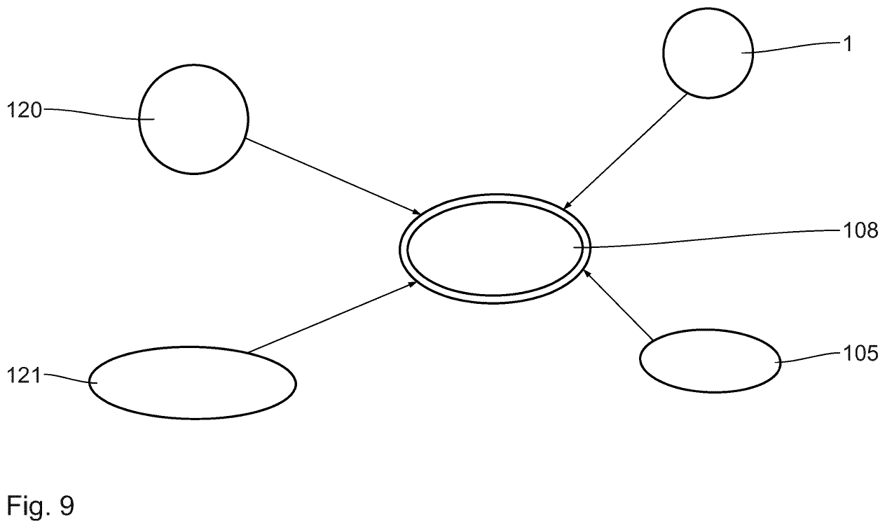

FIG. 9 is a simplified representation of the control process for the system,

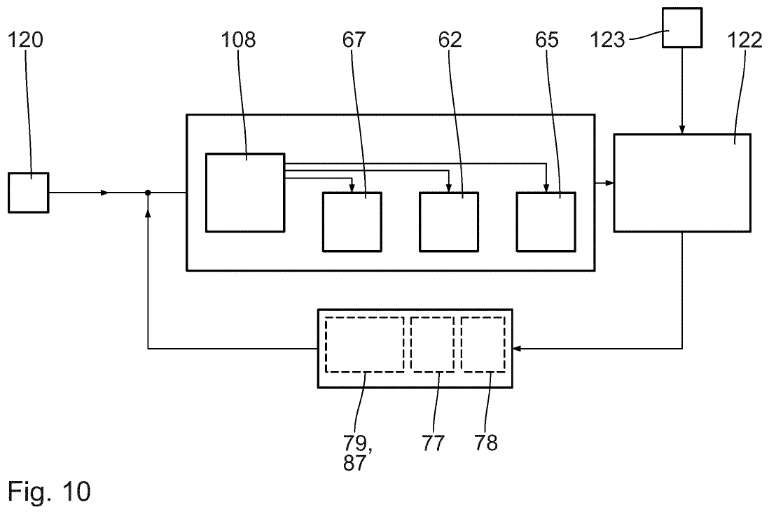

FIG. 10 is a block diagram illustrating a tension difference control process of the system shown, and

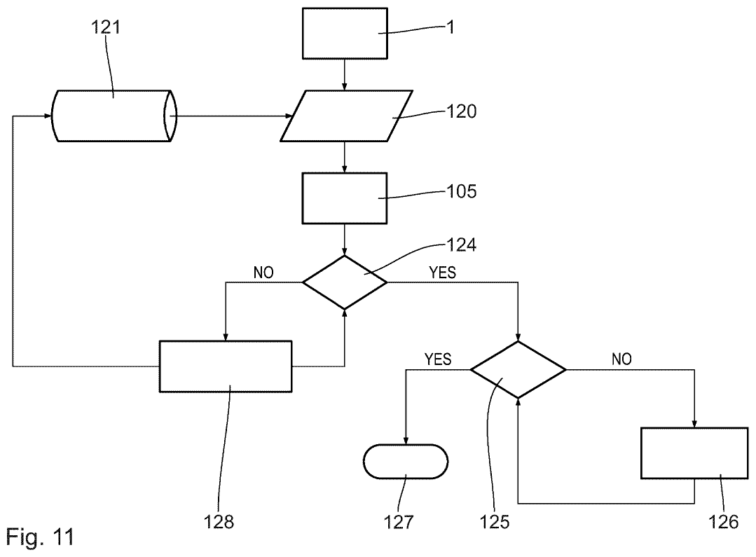

FIG. 11 is another block diagram showing the tension difference control process for the system shown.

A corrugator 1 shown in its entirety in FIGS. 1 and 2 comprises a first corrugated-cardboard production device 2 for producing a continuous first corrugated cardboard web which is laminated on one side.

A first cover web splicing device 3 and a first material web splicing device 4 are arranged upstream of the first corrugated-cardboard production device 2.

The first cover web splicing device 3 comprises a first unrolling unit 6 for unrolling a continuous first cover web from a first cover web reel 5 and a second unrolling unit 8 for unrolling a continuous second cover web from a second cover web reel 7. The continuous first cover web and second cover web are joined to one another to provide a continuous first cover web 9 by means of a joining and cutting unit (not shown) of the first cover web splicing device 3.

The first material web splicing device 4 is designed corresponding to the first cover web splicing device 3. Said first material web splicing device comprises a third unrolling unit 11 for unrolling a continuous first material web from a first material web reel 10 and a fourth unrolling unit 13 for unrolling a continuous second material web from a second material web reel 12. The continuous first material web and second material web are joined to one another to provide a continuous first material web 14 by means of a joining and cutting unit (not shown) of the first material web splicing device 4.

The continuous first cover web 9 is fed via a first heating roller 15 to a first heating device 16 and via a first tension control device 17 to the first corrugated-cardboard production device 2. The first heating device 16 is capable of heating the continuous first cover web 9. The first tension control device 17 is able to change or control the tension of the continuous first cover web 9. The continuous first material web 14 is fed to the first corrugated-cardboard production device 2 via deflection rollers.

The first corrugated-cardboard production device 2 comprises a first corrugating roller assembly 18 with a first corrugating roller 19 and a second corrugating roller 20 for producing a continuous first web from the continuous first material web 14, which continuous first web is corrugated. The corrugating rollers 19, 20 form a first corrugating roller gap for the passage and corrugation of the continuous first material web 14. The axes of rotation of the corrugating rollers 19, 20 run in parallel with one another and perpendicularly to the continuous first material web 14.

In order to join the continuous first cover web 9 with the continuous corrugated first material web or corrugated web 14 to form a continuous first corrugated cardboard web 21 which is laminated on one side, the first corrugated-cardboard production device 2 has a first glue application apparatus 22, which preferably comprises a first glue metering roller, a first glue container and a first glue application roller. For guiding the continuous first corrugated web 14 through and gluing it, the first glue application roller forms a first gluing gap together with the first corrugating roller 19. The glue in the first glue container is applied to tips of the corrugation of the continuous first corrugated web 14 via the first glue application roller. The first glue metering roller rests against the first glue application roller and serves to form an even layer of glue on the first glue application roller.

The continuous first cover web 9 is then joined with the continuous first corrugated web 14 provided with glue from the first glue container in the first corrugated-cardboard production device 2. In order to press the continuous first cover web 9 against the continuous first corrugated web 14 provided with glue, which in turn rests against regions of the first corrugating roller 19, the first corrugated-cardboard production device 2 has a first pressure module 25 which is expediently designed as a pressure belt module. Said first pressure module is arranged above the first corrugating roller 19 and has two first deflection rollers as well as a continuous first pressure belt which is guided around the two first deflection rollers. The first corrugating roller 19 partially engages from below in a space between the two first deflection rollers of the first pressure module 23, whereby the first pressure belt 27 is deflected by the first corrugating roller 19. The first pressure belt presses against the continuous first cover web 9, which in turn is pressed against the continuous first corrugated web 14 provided with glue and resting against the first corrugating roller 19.

In order to immediately store and buffer the continuous first corrugated cardboard web 21 which is laminated on one side, said web is fed via a first overhead transport apparatus 24 to a first storage device 25 of the corrugator 1, where it forms or can form loops.

The first storage device 25 has a first transport apparatus for transporting the continuous first corrugated cardboard web 21 which is laminated on one side. The first transport apparatus forms a transport path for the continuous first corrugated cardboard web 21 which is laminated on one side. A first impeller 106 is mounted in the first transport apparatus so as to be rotatable or capable of being driven in rotation. When the continuous first corrugated cardboard web 21 which is laminated on one side is transported by the first transport apparatus, it is conveyed along the first transport wheel 106 and causes it to rotate.

Furthermore, the corrugator 1 has a second corrugated-cardboard production device 26, which is designed in accordance with the first corrugated-cardboard production device 2 and serves to produce a continuous second corrugated cardboard web which is laminated on one side.

A second cover web splicing device 27 and a second material web splicing device 28 are arranged upstream of the second corrugated-cardboard production device 26.

The second cover web splicing device 27 comprises a fifth unrolling unit 30 for unrolling a continuous third cover web from a third cover web reel 29 and a sixth unrolling unit 32 for unrolling a continuous fourth cover web from a fourth cover web reel 31. The continuous third cover web and fourth cover web are joined to one another by means of a joining and cutting unit (not shown) of the second cover web splicing device 27 in order to provide a continuous second cover web 33.

The second material web splicing device 28 comprises a seventh unrolling unit 35 for unrolling a continuous third material web 41 from a third material web reel 34 and an eighth unrolling unit 37 for unrolling a continuous fourth material web from a fourth material web reel 36. The continuous third material web and fourth material web are joined to one another by means of a joining and cutting unit (not shown) of the second material web splicing device 28 to provide a continuous second material web 38.

The continuous second cover web 33 is fed via a second heating roller 39 to a second heating device 40 and via a second tension control device 41 to the second corrugated-cardboard production device 26. The second heating device 40 is capable of heating the continuous second cover web 33. The second tension control device 41 is capable of changing or controlling the tension of the continuous second cover web 33. The continuous second material web 38 is fed to the second corrugated-cardboard production device 26 via deflection rollers.

The second corrugated-cardboard production device 26 comprises a second corrugating roller assembly 42 with a third corrugating roller 43 and a fourth corrugating roller 44 for producing a continuous second web which is corrugated from the continuous second material web 38. The corrugating rollers 43, 44 form a second corrugating roller gap for the passage and corrugation of the continuous second material web 38. The axes of rotation of the corrugating rollers 43, 44 extend in parallel with one another and perpendicularly to the continuous second material web 38.

In order to connect the continuous second cover web 33 to the continuous corrugated second material web or corrugated web 38 to form a continuous second corrugated cardboard web 45 which is laminated on one side, the second corrugated-cardboard production device 26 has a second glue application apparatus 46, which preferably comprises a second glue metering roller, a second glue container and a second glue application roller. In order to guide the continuous second corrugated web 38 through and glue it, the second glue application roller forms a second gluing gap together with the third corrugating roller 43. The glue in the second glue container is applied to tips of the corrugation of the continuous second corrugated web 38 via the second glue application roller. The second glue metering roller rests against the second glue application roller and serves to form an even layer of glue on the second glue application roller.

The continuous second cover web 33 is then joined with the continuous second corrugated web 38 provided with glue from the second glue container in the second corrugated-cardboard production device 26. In order to press the continuous second cover web 33 against the continuous second corrugated web 38 provided with glue, which in turn rests against regions of the third corrugating roller 43, the second corrugated-cardboard production device 26 has a second pressure module 47. The second pressure module 47 is advantageously designed as a pressure belt module. It is arranged above the third corrugating roller 43. The second pressure module 47 has two second deflection rollers and a continuous second pressure belt which is guided around the two second deflection rollers. The third corrugating roller 43 partially engages from below in a space between the two second deflection rollers, whereby the second pressure belt is deflected by the third corrugating roller 43. The second pressure belt presses against the continuous second cover web 33, which in turn is pressed against the continuous second corrugated web 38 provided with glue and resting against the third corrugating roller 43.

In order to immediately store and buffer the continuous second corrugated cardboard web 45 which is laminated on one side, said web is fed via a second overhead transport apparatus 48 to a second storage device 49 of the corrugator 1, where it forms or can form loops.

The second storage device 49 has a second transport apparatus for transporting the continuous second corrugated cardboard web 45 which is laminated on one side. The second transport apparatus forms a transport path for the continuous second corrugated cardboard web 45 which is laminated on one side. A second impeller 107 is mounted in the second transport apparatus so as to be rotatable or capable of being driven in rotation. When the continuous second corrugated cardboard web 45 which is laminated on one side is transported by the second transport apparatus, it is conveyed along the second transport wheel 107 and causes it to rotate.

The continuous first corrugated cardboard web 21 which is laminated on one side is fed via the first overhead transport apparatus 24 to a bridge 50 of the corrugator 1 in order to convey it further. The continuous second corrugated cardboard web 45 which is laminated on one side is also fed via the second overhead transport apparatus 48 to the bridge 50 in order to convey it further.

The bridge 50 carries a first de-looping device 51 in a downstream end region by means of first de-looping rollers 52, where they ensure that the continuous first corrugated cardboard web 21 which is laminated on one side is de-looped. The first de-looping rollers 52 are arranged at a common height so as to be at a substantial horizontal spacing from one another and extend transversely to a transport direction of the continuous first corrugated cardboard web 21 which is laminated on one side. The continuous first corrugated cardboard web 21 which is laminated on one side is guided through the first de-looping device 51.

The bridge 50 also carries a second de-looping device 53 in its downstream end region, which is designed in a similar manner to the first de-looping device 51, where it ensures that the continuous second corrugated cardboard web 45 which is laminated on one side is de-looped. The second de-looping device 53 is arranged below the first de-looping device 51 and comprises second de-looping rollers 54. The second de-looping rollers 54 are arranged at a common height so as to be at a substantial horizontal spacing from one another and extend transversely to a transport direction of the continuous second corrugated cardboard web 45 which is laminated on one side. The continuous second corrugated cardboard web 45 which is laminated on one side is guided through the second de-looping device 53.

Downstream of the first de-looping device 51, a first guide device 55 for guiding the continuous first corrugated cardboard web 21 which is laminated on one side is arranged on the bridge 50. Here, the first guide device 55 detects a transverse position of the continuous first corrugated cardboard web 21 which is laminated on one side. If necessary, it corrects the transverse position of the continuous first corrugated cardboard web 21 which is laminated on one side and in particular ensures—if necessary—a transverse alignment of the continuous first corrugated cardboard web 21 which is laminated on one side with respect to a center of the system or to the continuous second corrugated cardboard web 42 which is laminated on one side or to a laminating web.

A first splice recording apparatus 57 is arranged in the first guide device 55 or adjacently thereto, which splice recording apparatus is capable of recording a change in a width of the continuous first corrugated cardboard web 21 which is laminated on one side and/or directly recording a splice point in the continuous first corrugated cardboard web 21 which is laminated on one side. For this purpose, the first splice recording apparatus 57 has a rotatable first recording web roller 58 resting on the continuous first corrugated cardboard web 21 which is laminated on one side and a contactless first scanning apparatus for scanning lateral regions of the continuous first corrugated cardboard web 21 which is laminated on one side.

Downstream of the second de-looping device 53, a second guide device 56 for guiding the continuous second corrugated cardboard web 45 which is laminated on one side is also arranged on the bridge 50. Here, the second guide device 56 detects a transverse position of the continuous second corrugated cardboard web 45 which is laminated on one side. If necessary, it corrects a transverse position of the continuous second corrugated cardboard web 45 which is laminated on one side and in particular ensures—if necessary—a transverse alignment of the continuous second corrugated cardboard web 45 which is laminated on one side with respect to the center of the system or to the continuous first corrugated cardboard web 21 which is laminated on one side or to the laminating web.

A second splice recording apparatus 59 is arranged in the second guide device 56 or adjacently thereto, which second splice recording apparatus is designed in a similar manner to the first splice recording apparatus 57 and is capable of recording a change in a width of the continuous second corrugated cardboard web 45 which is laminated on one side and/or directly recording a splice point in the continuous second corrugated cardboard web 45 which is laminated on one side. For this purpose, the second splice recording apparatus 59 has a rotatable second recording web roller 60 resting on the continuous second corrugated cardboard web 45 which is laminated on one side and a contactless second scanning apparatus for scanning lateral regions of the continuous second corrugated cardboard web 45 which is laminated on one side. The splice points can be synchronized.

Downstream of the first guide device 55, a first tension changing roller 61 is arranged on the bridge 50, which is preferably rubberized and can be driven and/or braked by a first drive 62, in particular a servo drive. The first drive 62 has a first torque measuring unit or a first torque measuring unit is assigned to the first drive 62. The first tension changing roller 61 in particular ensures a taut or tensioned continuous first corrugated cardboard web 21 which is laminated on one side and the tension of which is preferably kept constant. The continuous first corrugated cardboard web 21 which is laminated on one side is guided around the first tension changing roller 61.

Deflection rollers 63 are arranged upstream and adjacently to the first tension changing roller 61.

Downstream of the second guide device 56, a second tension changing roller 64 is arranged on the bridge 50, which is preferably rubberized and can be driven and/or braked by a second drive 65, in particular a servo drive. The second drive 65 has a second torque measuring unit or a second torque measuring unit is assigned to the second drive 65. The second tension changing roller 64 in particular ensures a taut or tensioned continuous second corrugated cardboard web 45 which is laminated on one side and the tension of which is preferably kept constant. The continuous second corrugated cardboard web 45 which is laminated on one side is guided around the second tension changing roller 64.

Deflection rollers 66 are arranged upstream and adjacently to the second tension changing roller 64.

The corrugator 1 also has a laminating-web splicing device 67, which comprises a ninth unrolling unit 69 for unrolling a continuous first laminating web from a first laminating web reel 68 and comprises a tenth unrolling unit 71 for unrolling a continuous second laminating web from a second laminating web reel 70. The continuous first laminating web and continuous second laminating web are joined to one another to provide a continuous laminating web 72 by means of a joining and cutting unit (not shown) of the laminating-web splicing device 67.

The ninth unrolling unit 69 and the tenth unrolling unit 71 each have an unrolling brake 69a and 71a, respectively, in order to optionally apply an unrolling braking force to the continuous first or second laminating web or the first 68 or second 70 laminating web reel, which preferably (also) depends on the current diameter of the first laminating web reel 68 or second laminating web reel 70.

Downstream of the tension changing rollers 61, 64 and the laminating-web splicing device 67, the corrugator 1 has a preheating device 73 which comprises three preheating rollers 74, 75, 76 arranged one above the other. The continuous corrugated cardboard webs 21, 45 which is laminated on one side and the continuous laminated web 72 are fed to the preheating device 73. The continuous first corrugated cardboard web 21 which is laminated on one side wraps around the first preheating roller 74 and is heated. The continuous second corrugated cardboard web 45 which is laminated on one side wraps around the second preheating roller 75 and is heated. The continuous laminating web 72 wraps around the third preheating roller 76 and is heated.

A first tension measuring roller 77 is arranged downstream and adjacently to the first preheating roller 74, which is in direct mechanical contact with the continuous first corrugated cardboard web 21 which is laminated on one side and is capable of measuring its mechanical (web) tension at this point. The first tension measuring roller 77 extends perpendicularly to the continuous first corrugated cardboard web 21 which is laminated on one side. It extends horizontally.

A second tension measuring roller 78 is arranged downstream and adjacently to the second preheating roller 75, which is in direct mechanical contact with the continuous second corrugated cardboard web 45 which is laminated on one side and is capable of measuring its mechanical (web) tension at this point. The second tension measuring roller 78 extends perpendicularly to the continuous second corrugated cardboard web 45 which is laminated on one side. It extends horizontally.

A third tension measuring roller 79 is arranged downstream and adjacently to the third preheating roller 76. The continuous laminating web 72 is guided around the third tension measuring roller 79. The third tension measuring roller 79 is in direct mechanical contact with the continuous laminating web 72 and is able to measure its mechanical (web) tension at this point. The third tension measuring roller 79 extends perpendicularly to the continuous laminating web 72. It extends horizontally.

As shown in FIG. 6, each tension measuring roller 77, 78, 79 has a force measuring bearing 80 on both sides, which is able to detect bearing forces which occur and thus determine the mechanical tension of the corresponding web 21, 45 or 72. Expediently, each force measuring bearing 80 comprises a radial force sensor.

As shown in FIG. 7, the first tension measuring roller 77, second tension measuring roller 78 and/or third tension measuring roller 79 can be assigned a guide roller 81 for guiding the corresponding web 21, 45 or 72. The tension measuring roller 77, 78 or 79 and the guide roller 81 are held by a holder 82 and run in parallel with one another.

Downstream of the tension measuring rollers 77, 78, 79, the corrugator 1 has a gluing facility 83 with a first gluing roller 84 and a second gluing roller 85, each of which is partially immersed in an associated glue bath. A glue metering roller 86 rests on each gluing roller 84, 85 in order to form a uniform glue layer on the associated gluing roller 84 or 85. The continuous first corrugated cardboard web 21 which is laminated on one side is in contact by means of its corrugated web 14 with the first gluing roller 84 so that its corrugation is provided with glue from the associated glue bath. The continuous second corrugated cardboard web 45 which is laminated on one side is in contact by means of its corrugated web 38 with the second gluing roller 85 such that its corrugation is provided with glue from the associated glue bath. The continuous laminating web 72 remains unglued in the gluing facility 83.

The gluing facility 83 also comprises a fourth tension measuring roller 87, which is designed, for example, in a similar manner to the tension measuring rollers 77, 78 or 79. The continuous laminating web 72 is guided around the fourth tension measuring roller 87 and is in direct mechanical contact therewith such that the fourth tension measuring roller 87 is able to measure its mechanical (web) tension at this point. The fourth tension measuring roller 79 extends perpendicularly to the continuous laminating web 72. It extends horizontally.

Downstream of the gluing facility 83, the corrugator 1 comprises a joining device 88 with a horizontally extending heating table 89. Adjacent to the heating table 89, the joining device 88 has a continuous pressure belt 90 guided around guide rollers. A pressing gap is formed between the pressure belt 90 and the heating table 89, through which the continuous glued corrugated cardboard webs 21, 45 which are laminated on one side and the continuous laminating web 72 are guided to form a continuous corrugated cardboard web 91 which is laminated on both sides. The continuous corrugated cardboard web 91 which is laminated on both sides has a total of five layers. The continuous first corrugated cardboard web 21 which is laminated on one side forms an upper first outer web of the continuous corrugated cardboard web 91 which is laminated on both sides. The continuous laminating web 72 forms a lower second outer web of the continuous corrugated cardboard web 91 which is laminated on both sides. The continuous second corrugated cardboard web 45 which is laminated on one side is arranged in an intermediate position or on the inside.

Downstream of the joining device 88, the corrugator 1 comprises a short cross-cutting device 92 which comprises at least one cross-cutting roller. The short cross-cutting device 92 is, for example, capable of cutting out rejects from the continuous corrugated cardboard web 91 which is laminated on both sides and/or of producing joining cuts during a format change between correspondingly changed longitudinal cuts in the continuous corrugated cardboard web 91 which is laminated on both sides.

Downstream of the short cross-cutting device 92, the corrugator 1 has a longitudinal cutting/grooving device 93 for longitudinally cutting and grooving the continuous corrugated cardboard web 91 which is laminated on both sides. The longitudinal cutting/grooving device 93 has two grooving stations arranged one behind the other and two longitudinal cutting stations arranged one behind the other. In the longitudinal cutting/grooving device 93, continuous partial webs 94, 95, which initially extend next to one another, can be produced from the continuous corrugated cardboard web 91 which is laminated on both sides by at least one longitudinal cut.

Downstream of the longitudinal cutting/grooving device 93, the corrugator 1 comprises a switch 96 to convey the continuous partial webs 94, 95 at different levels.

Downstream of the switch 96, the corrugator 1 comprises a cross-cutting device 97 with two cross-cutting apparatuses 98, 99 arranged one above the other. Each cross-cutting apparatus 98, 99 has two cutter bar rollers arranged in pairs with radially projecting cutter bars. To cross-cut the continuous partial webs 94, 95, the cutter bars of the cutter bar rollers of the corresponding cross-cutting apparatus 98 or 99 cooperate.

A conveyor belt apparatus 100 or 101 is arranged downstream of each cross-cutting apparatus 98, 99 in order to further convey corrugated cardboard sheets 102 produced from the continuous partial webs 94, 95 by the cross-cutting apparatuses 98, 99.

Each conveyor belt apparatus 100, 101 is followed by a storage device 103, which is expediently height-adjustable. In the storage devices 103, the corrugated cardboard sheets 102 can be stacked on top of one another to form stacks 104.

The system further comprises curvature determination devices 105 which are arranged above the stacks 104 in the storage devices 103 and are capable of determining or measuring a prevailing curvature of each corrugated cardboard sheet 102 in the longitudinal direction. The curvature determination devices 105 can be part of the corrugator 1. The corrugated cardboard sheets can, for example, be curved upward or downward. S-shaped curvatures are also possible.

The system also comprises a processing assembly 108, which is designed as an electrical or electronic control assembly and serves in particular to control the web tensions.

The first impeller 106 is at least temporarily connected to the processing assembly 108 for transmitting signals via a first signal line 109. The processing order 108 is thus supplied with signals or information relating to a rotational speed of the first impeller 106. The length of the currently stored continuous first corrugated cardboard web 21 which is laminated on one side can be calculated via the first impeller 106.

The second impeller 107 is at least temporarily connected to the processing assembly 108 for transmitting signals via a second signal line 110. The processing order 108 is thus supplied with signals or information relating to a rotational speed of the second impeller 107. The second impeller 107 can be used to calculate the length of the currently stored continuous second corrugated cardboard web 45 which is laminated on one side.

The first rolling brake 69a is at least temporarily connected to the processing assembly 108 for transmitting signals via a third signal line 111 and is able to receive actuation signals from the processing assembly 108.

The second rolling brake 71a is at least temporarily connected to the processing assembly 108 for transmitting signals via a fourth signal line 112 and is able to receive actuation signals from the processing assembly 108.

The first recording web roller 58 is at least temporarily connected to the processing assembly 108 for transmitting signals via a fifth signal line 113 in order to supply the processing assembly 108 with signals relating to a time when a splice point was recorded in the continuous first corrugated cardboard web 21 which is laminated on one side.

The second recording web device 60 is at least temporarily connected to the processing assembly 108 for transmitting signals via a sixth signal line 114 in order to supply the processing assembly 108 with signals relating to a time when a splice point was recorded in the continuous second corrugated cardboard web 45 which is laminated on one side.

The first tension measuring roller 77 is at least temporarily connected to the processing assembly 108 for transmitting signals via a seventh signal line 115 in order to supply the processing assembly 108 with signals which relate to the current mechanical tension of the continuous first corrugated cardboard web 21 which is laminated on one side at the first tension measuring roller 77.

The second tension measuring roller 78 is at least temporarily connected to the processing assembly 108 for transmitting signals via an eighth signal line 116 in order to supply the processing assembly 108 with signals which relate to the current mechanical tension of the continuous second corrugated cardboard web 45 which is laminated on one side at the second tension measuring roller 78.

The third tension measuring roller 79 is at least temporarily connected to the processing assembly 108 for transmitting signals via a ninth signal line 117 in order to supply the processing assembly 108 with signals which relate to the current mechanical tension of the continuous laminating web 72 at the third tension measuring roller 79.

The fourth tension measuring roller 87 is at least temporarily connected to the processing assembly 108 for transmitting signals via a tenth signal line 118 in order to supply the processing assembly 108 with signals relating to the current mechanical tension of the continuous laminating web 72 at the fourth tension measuring roller 87.

Each curvature determination device 105 is at least temporarily connected to the processing assembly 108 for transmitting signals via an eleventh signal line 119 in order to supply the processing assembly 108 with signals relating to a curvature in the longitudinal direction of the last-recorded corrugated cardboard sheet 102.

The first drive 62 is at least temporarily connected to the processing assembly 108 for transmitting signals via a twelfth signal line 129 and is able to receive actuation signals from the processing assembly 108.

The second drive 65 is at least temporarily connected to the processing assembly 108 for transmitting signals via a thirteenth signal line 130 and is able to receive actuation signals from the processing assembly 108.

In addition to the corrugator 1, the system also comprises a superordinate electrical or electronic specification assembly 120, which is at least temporarily connected to the processing assembly 108 for transmitting signals in order to specify the tension.

The following shall initially provide a rough explanation of the operation of the system or the control process for the corrugator 1. The control process is illustrated in a highly simplified manner in FIG. 9. As already mentioned, the processing assembly 108 is supplied with electrical signals or information from the corrugator 1, the curvature determination devices 105, the specification assembly 120 and, if necessary, also from a quality data memory 121. The processing assembly 108 processes this information.

The control system is shown in more detail in FIG. 10. The tension difference is controlled by means of the processing assembly 108. A tension difference is preferably specified via a slider of the specification assembly 120 of the corrugator 1.

The processing assembly 108 receives corresponding signals or information from the specification assembly 120 and is able to correspondingly actuate the laminating-web splicing device 67, in particular its unrolling brakes 69a or 71a, the first drive 62 and/or the second drive 65, if necessary. The laminated web splicing device 67, in particular its unrolling brakes 69a and 71a, the first drive 62 and the second drive 65 form actuators. In this way, the mechanical tension of the continuous first corrugated cardboard web 21 which is laminated on one side, the continuous second corrugated cardboard web 45 which is laminated on one side or the continuous laminating web 72 is changed or specifically influenced as required or to the required extent.

The control system contains the continuous first corrugated cardboard web 21 which is laminated on one side, the continuous second corrugated cardboard web 45 which is laminated on one side and/or the continuous laminating web 72 up to the tension measuring rollers 77, 78, 79 or 87. This control system is assigned reference numeral 122 in FIG. 10. The controlled variable here is the mechanical tension of the continuous first corrugated cardboard web 21 which is laminated on one side, the continuous second corrugated cardboard web 45 which is laminated on one side or the continuous laminating web 72, which is controlled or specifically influenced.

Signals, illustrated by reference numeral 123 in FIG. 10, can be fed to the control system 122. These signals can relate to a quality of the corrugated cardboard sheets 102, a change in the speed of the corrugator 1, at least in some regions, and/or operating signals of the laminating-web splicing device 67.

An output variable of the control system 122 is preferably fed to the third tension measuring roller 79, the fourth tension measuring roller 87, the first tension measuring roller 77 and/or the second tension measuring roller 78.

Measured signals from the third tension measuring roller 79, fourth tension measuring roller 87, first tension measuring roller 77 and second tension measuring roller 78, which correlate with the corresponding measured mechanical web tension, are fed to the processing assembly 108. The processing assembly 108 processes the measured signals or the information. A control loop exists.

The mechanical tensions of the first outer web and the second outer web measured by means of the tension measuring rollers 77, 78, 79 and 87 are then compared with one another and, if necessary, controlled. The processing assembly 108 uses a control deviation or control difference to determine a manipulated variable which accordingly acts on the control system 122.

In particular, the master outer web is defined as a controlled variable. The slave outer web is automatically adjusted and controlled at the same value or adjusted in terms of the same change, i.e. the same difference or deviation is maintained as originally intended.

With reference to FIG. 11, the principle of the web tension difference control process in the laminating region of the corrugator 1 is described in more detail. The corrugator 1 is currently in operation.

First, a tension is specified for the master outer web, which can be freely selected, via the specification assembly 120. As mentioned, the tension of the slave outer web is automatically adapted or aligned.

The curvature of the corrugated cardboard sheets 102 is then determined by the curvature determination devices 105. As mentioned, this can alternatively also be done manually.

Thereafter, in a step 124, a check is carried out to determine whether the corrugated cardboard sheets 102 have or maintain a desired degree of flatness in the longitudinal direction.

If the corrugated cardboard sheets 102 have or maintain the desired degree of flatness in the longitudinal direction, a check is carried out in a step 125 to determine whether the tensions of the continuous first corrugated cardboard web 21 which is laminated on one side, the continuous second corrugated cardboard web 45 which is laminated on one side and/or the continuous laminated web 72 are appropriate. As mentioned, the tensions are measured by means of the third tension measuring roller 79, fourth tension measuring roller 87, first tension measuring roller 77 or second tension measuring roller 78.

If the tensions of the continuous first corrugated cardboard web 21 which is laminated on one side, the continuous second corrugated cardboard web 45 which is laminated on one side and/or the continuous laminating web 72 are not suitable, a web tension level is adapted in a step 126.

If the check in step 125 shows that the tensions of the continuous first corrugated cardboard web 21 which is laminated on one side, the continuous second corrugated cardboard web 45 which is laminated on one side and/or the continuous laminating web 72 are OK, no change in the web tension level is necessary, as illustrated in step 127. The control process has finished.

If the test in step 124 shows that the flatness of the corrugated cardboard sheets 102 in the longitudinal direction is not correct or is not maintained, the web tension difference is adapted in a step 128 by a corresponding web tension difference control process by the processing assembly 108. This is continued until the flatness of the corrugated cardboard sheets 102 in the longitudinal direction is correct or maintained. For this purpose, the laminating-web splicing device 67, in particular its unrolling brakes 69a and 71a, the first drive 62 and the second drive 65, if necessary, are actuated accordingly.

If the flatness of the corrugated cardboard sheets 102 in the longitudinal direction is then correct or maintained, the correction data are stored in the quality data memory 121. They can be retrieved from the specification assembly 120 if required.

When creating a new quality for which empirical values are still lacking, it is preferable that the tension of the first outer web is equal to that of the second outer web.

If there are loose edges on the continuous first corrugated cardboard web 21 which is laminated on one side, the continuous first corrugated cardboard web 21 which is laminated on one side requires higher tension. This is preferably set by the operator.

For example, if the first outer web has wrinkles, this may require a change in the tension of the second outer web and is requested accordingly by the operator. The second outer web requires more tension or less tension.

If the continuous laminating web 72 or the continuous first corrugated cardboard web 21 which is laminated on one side flutters, greater tension is necessary.

As the corrugated cardboard sheet 102 curves upward (upward curvature), the tension of the inner cover is decreased and/or the tension of the outer cover is increased depending on a distance from a maximum or minimum limit value. The value which is further away from the corresponding limit value is preferably the one that is changed. The measured tensions in the laminating region in particular serve as controlled variables. Therefore, it is first determined whether the outer cover or the inner cover is closer to the limit values.

As the corrugated cardboard sheet 102 curves downward (downward curvature), the tension of the inner cover is increased and/or the tension of the outer cover is reduced depending on a distance from a maximum or minimum limit value. The value which is further away from the corresponding limit value is preferably the one that is changed. The measured tensions in the laminating region in particular serve as controlled variables. Therefore, it is first determined whether the outer cover or the inner cover is closer to the limit values.

The signal connections specified here are, for example, wireless or wired connections. Not all signal lines of the corrugator 1 are shown. The terms “downstream,” “upstream” or the like that are used generally refer to the transport direction of an associated web.

1. A system comprising:
a. a corrugator, having
i. a first corrugated-cardboard production device for producing a first corrugated cardboard web which is laminated on one side,
ii. a laminating-web unrolling device for unrolling a laminating web
iii. a joining device arranged downstream of the first corrugated-cardboard production device and the laminating-web unrolling device for joining the first corrugated cardboard web which is laminated on one side and the laminating web together to form a corrugated cardboard web which is laminated on both sides and which has a first outer web and a second outer web, and
iv. at least one cutting device arranged downstream of the joining device for producing corrugated cardboard sheets from the corrugated cardboard web which is laminated on both sides, and
b. a processing assembly which is designed to automatically adapt a tension of the second outer web to a tension of the first outer web if necessary, so that, at least in the transport direction of the corrugated cardboard sheets the corrugated cardboard sheets are flat or adhere to flatness target values.

2. The system according to claim 1, further comprising a specification assembly which is at least temporarily connected to the processing assembly for transmitting signals and is intended for specifying the tension of only the first outer web.

3. The system according to claim 1, wherein the tension of the second outer web is not specified.

4. The system according to claim 1, wherein the first outer web forms a master outer web and the second outer web forms a slave outer web and produces a master-slave tension adaptation.

5. The system according to claim 1, wherein the processing assembly has a tension comparison unit which compares the currently prevailing tension of the first outer web and the currently prevailing tension of the second outer web.

6. The system according to claim 5, wherein a difference between the currently prevailing tension of the first outer web and the currently prevailing tension of the second outer web is adjustable.

7. The system according to claim 5, wherein the processing assembly adapts the tension of the second outer web to match the tension of the first outer web.

8. The system according to claim 5, wherein a difference between the currently prevailing tension of the first outer web and the currently prevailing tension of the second outer web is controlled.

9. The system according to claim 1, wherein the laminating web or the first corrugated cardboard web which is laminated on one side forms or comprises the first outer web and the other web forms or comprises the second outer web.

10. The system according to claim 1, wherein the corrugator comprises at least one laminating web tension changing device which is assigned to the laminating web and is at least temporarily connected to the processing assembly for transmitting signals in order to change the tension of the laminating web where necessary.

11. The system according to claim 1, wherein the corrugator comprises at least one first corrugated cardboard web tension changing device which is assigned to the first corrugated cardboard web laminated on one side and is at least temporarily connected to the processing assembly for transmitting signals in order to change the tension of the first corrugated cardboard web which is laminated on one side if necessary, at least one first corrugated cardboard web tension changing device preferably being arranged between the first corrugated-cardboard production device and the joining device.

12. The system according to claim 1, wherein the corrugator comprises at least one laminating-web tension measuring device which is assigned to the laminating web and is at least temporarily connected to the processing assembly for transmitting signals, at least one laminating-web tension measuring device preferably being arranged between the laminating-web unrolling device and the joining device preferably downstream of a laminating-web preheating apparatus for preheating the laminating web.

13. The system according to claim 1, wherein the corrugator comprises at least one first corrugated cardboard web tension measuring device which is assigned to the first corrugated cardboard web laminated on one side and is at least temporarily connected to the processing assembly for transmitting signals in order to measure the tension of the first corrugated cardboard web which is laminated on one side, at least one first corrugated cardboard web tension measuring device being arranged upstream of the joining device downstream of a corrugated-cardboard web preheating apparatus for preheating the first corrugated cardboard web which is laminated on one side.

14. The system according to claim 1, wherein the corrugator comprises at least one curvature determination device which is assigned to the corrugated cardboard sheets and is at least temporarily connected to the processing assembly for transmitting signals in order to determine a currently prevailing curvature of the corrugated cardboard sheets.

15. A method for producing corrugated cardboard, comprising the steps of
producing a first corrugated cardboard web which is laminated on one side by means of a first corrugated-cardboard production device,
unrolling a laminating web from a laminating-web unrolling device,
joining the first corrugated cardboard web which is laminated on one side and the laminating web together to form a corrugated cardboard web which is laminated on both sides by means of a joining device arranged downstream of the first corrugated-cardboard production device and the laminating-web unrolling device the corrugated cardboard web which is laminated on both sides comprising a first outer web and a second outer web,
producing corrugated cardboard sheets from the corrugated cardboard web which is laminated on both sides by means of at least one cutting device arranged downstream of the joining device and
automatically adapting a tension of the second outer web to a tension of the first outer web by means of a processing assembly if necessary, so that, at least in the transport direction of the corrugated cardboard sheets the corrugated cardboard webs are flat or adhere to flatness target values.
